(19) United States
(12) Patent Application Publication
(10) Pub. No.: US 2021/0043964 A1
(43) Pub. Date: Feb. 11, 2021

(54) UNIFORM PRESSURE BATTERY PACKAGING APPARATUS

(71) Applicant: Intel Corporation, Santa Clara, CA (US)

(72) Inventors: Naoki Matsumura, San Jose, CA (US); Juha Paavola, Hillsboro, OR (US); Mikko Makinen, Santa Clara, CA (US); Vivek Paranjape, Hillsboro, OR (US); Andy Keates, Los Gatos, CA (US)

(73) Assignee: Intel Corporation, Santa Clara, CA (US)

(21) Appl. No.: 16/943,982

(22) Filed: Jul. 30, 2020

Related U.S. Application Data
(60) Provisional application No. 62/884,090, filed on Aug. 7, 2019.

(51) Int. Cl. H01M 10/058; H01M 10/0525

(52) U.S. Cl. CPC H01M 10/058; H01M 10/0525

(57) ABSTRACT

Li-metal battery with a pressure chamber to allow uniform pressure on a battery. The pressure chamber is supported by metal plates (such as pressure equalization plate) used to give uniform pressure to the battery. The pressure chamber may include pressured gas, elastic material, spring plate, etc. The outer skin of the pressure chamber is free to bow, restrained at its edges by (metal) skin, but still exerts a uniform pressure on the plate that is compressing the battery cell. The pressure chamber gives uniform pressure to battery, which is used to enable high-energy density battery with, for example, 20% more battery life.

### CLAIM OF PRIORITY

This application claims the benefit of priority to U.S. Provisional Patent Application No. 62/884,090, filed on Aug. 7, 2020, titled “UNIFORM PRESSURE BATTERY PACKAGING APPARATUS,” and which is incorporated by reference in its entirety.

### BACKGROUND

Lithium-ion (Li-ion) battery is widely used as an energy storage device for computing system. Swelling in existing batteries cause ununiformed pressure, resulting in poor cycle life of the battery.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates a cross-sectional view of a typical Li-ion battery.

FIGS. 2A-B illustrate cross-sectional view of Li-metal rechargeable battery in discharged state and during charged state, respectively.

FIGS. 3A-B illustrate cross-sectional view of Li-metal rechargeable battery in charged state and during discharge state, respectively.

FIG. 4 illustrates a cross-sectional view of typical packaging system.

FIG. 5 illustrates a cross-sectional view of a packaging system with pressure chamber, in accordance with some embodiments.

FIG. 6 illustrates a flow chart of a method of forming a Li-metal battery with pressure chamber to apply uniform pressure to the battery, in accordance with some embodiments.

FIG. 7 illustrates a plot showing simulation result of pressure distribution with 0.2 MPa is applied from the pressure chamber on the top of the cell, in accordance with some embodiments.

FIG. 8 illustrates a cross-sectional simulation result of battery displacements when 0.2 MPa is applied from pressure chamber on the left of the cell, in accordance with some embodiments.

FIG. 9 illustrates a smart device or a computer system or a SoC (System-on-Chip) powered by a Li-ion battery of some embodiments.

### DETAILED DESCRIPTION

Li-metal anodes are proposed to increase the amount of energy stored in the battery. However, Li-metal anodes swell during charge and need to be held under pressure to hold the Li-metal particles together as the charge process adds more lithium metal to the anode. Thick enclosure, when used to mitigate swelling, results in ununiformed pressure, resulting in poor cycle life. For example, pressure when applied by rigid end-cap is constrained by a rigid skin. Since the end cap is only anchored at its ends, pressure exerted by the cell may cause the end cap to bow, creating a higher pressure on the cell at the edges, where the cap is restrained, and a lesser pressure in the center where the cap may free to bow.

Some embodiments address the need to apply pressure in a uniform manner to enable a Li-metal battery to function with good cycle life. In some embodiments, a pressure chamber is provided which is supported by metal plates (such as pressure equalization plate) used to give uniform pressure to a battery. The pressure chamber may include pressured gas, elastic material, spring plate, etc.

There are many technical effects of various embodiments. For example, the outer skin of the pressure chamber is free to bow, restrained at its edges by (metal) skin, but still exerts a uniform pressure on the plate that is compressing the battery cell. The pressure chamber gives uniform pressure to battery, which is used to enable high-energy density battery with, for example, 20% more battery life. Simulation result shows that this packaging gives almost no impact on battery size because the packaging takes some space in a system, but that is offset by making chassis thinner without impact on mechanical strength. Other technical effects will be evident from the various figures and embodiments.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “adjacent” here generally refers to a position of a thing being next to (e.g., immediately next to or close to with one or more things between them) or adjoining another thing (e.g., abutting it).

The term “circuit” or “module” may refer to one or more passive and/or active components that are arranged to cooperate with one another to provide a desired function.

The term “signal” may refer to at least one current signal, voltage signal, magnetic signal, or data/clock signal. The meaning of “a,” “an,” and “the” include plural references. The meaning of “in” includes “in” and “on.”

The term “scaling” generally refers to converting a design (schematic and layout) from one process technology to another process technology and may be subsequently being reduced in layout area. In some cases, scaling also refers to upsizing a design from one process technology to another process technology and may be subsequently increasing layout area. The term “scaling” generally also refers to downsizing or upsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

The terms “left,” “right,” “front,” “back,” “top,” “bottom,” “over,” “under,” and the like in the description and in the claims, if any, are used for descriptive purposes and not necessarily for describing permanent relative positions.

It is pointed out that those elements of the figures having the same reference numbers (or names) as the elements of any other figure can operate or function in any manner similar to that described but are not limited to such.

For purposes of the embodiments, the transistors in various circuits and logic blocks described here are metal oxide semiconductor (MOS) transistors or their derivatives, where the MOS transistors include drain, source, gate, and bulk terminals. The transistors and/or the MOS transistor derivatives also include Tri-Gate and FinFET transistors, Gate All Around Cylindrical Transistors, Tunneling FET (TFET), Square Wire, or Rectangular Ribbon Transistors, ferroelectric FET (FeFETs), or other devices implementing transistor functionality like carbon nanotubes or spintronic devices. MOSFET symmetrical source and drain terminals i.e., are identical terminals and are interchangeably used here. A TFET device, on the other hand, has asymmetric Source and Drain terminals. Those skilled in the art will appreciate that other transistors, for example, Bi-polar junction transistors (BJT PNP/NPN), BiCMOS, CMOS, etc., may be used without departing from the scope of the disclosure.

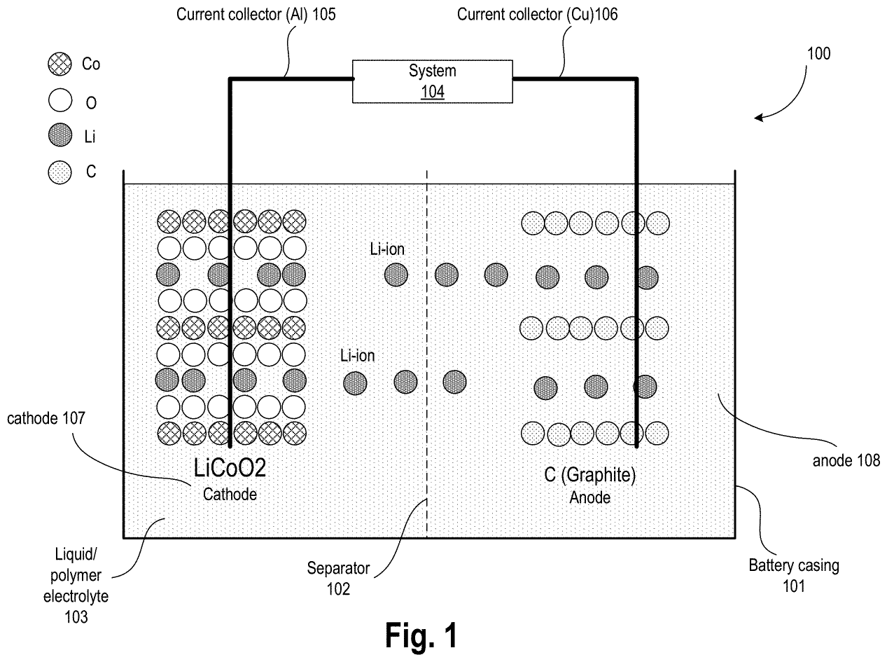

FIG. 1 illustrates a cross-sectional view of a typical Li-ion battery 100. Li-ion battery 100 consists of battery casing 101, separator 102, liquid polymer electrolyte 103, system 104 and current collectors 105 and 106. Liquid or polymer electrolyte 103 is in between cathode 105 current collector (e.g., Al), anode 106 current collector (e.g., Cu), cathode region 107, and anode region 108. Cathode current collector 105 is coupled to cathode region 107, while anode current collector 106 is coupled to anode region 108. During charge/discharge, Li-ion move between cathode 107 and anode 108 through electrolyte 103. As higher battery energy density is desired, rechargeable battery such as Li-metal rechargeable battery that gives about 20+% higher energy density can be used.

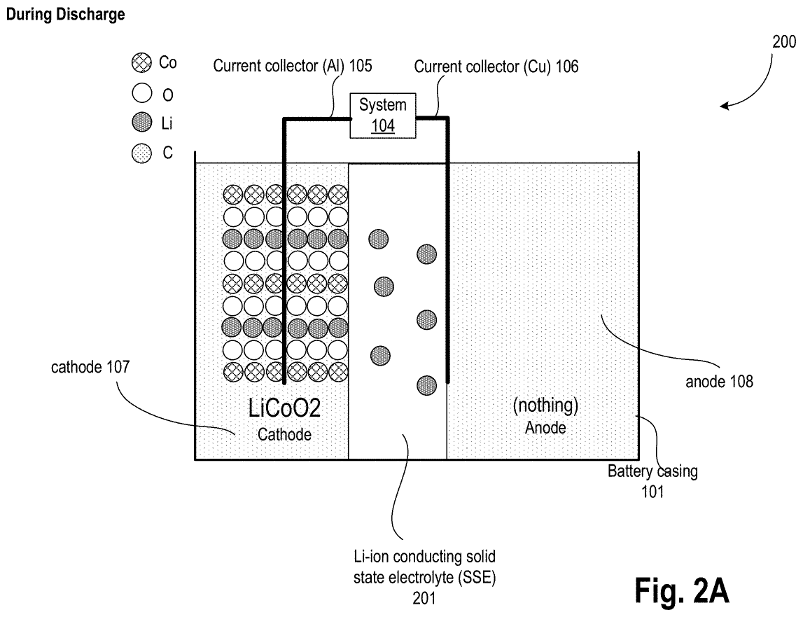

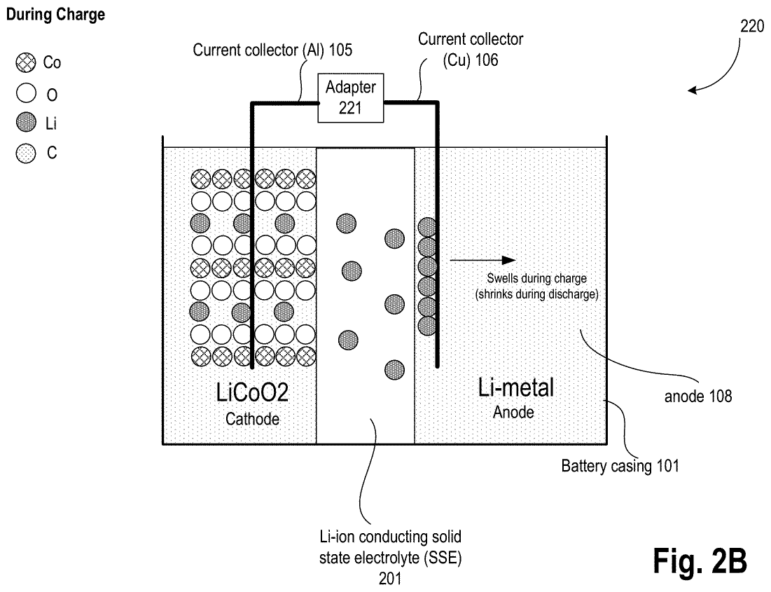

FIGS. 2A-B illustrate cross-sectional views of Li-metal rechargeable battery 200, 220 in discharged state and during charged state, respectively. These figures show an example of Li metal rechargeable battery. In this battery, there is no/little anode material at discharged state (FIG. 2A). During charge, adaptor 221 is coupled to cathode current collector 105 and anode current collector 106. Li-ion moves through electrolyte 201 (or solid-state electrolyte region) and is plated on the copper anode current collector 106 (FIG. 2B). The anode region 108 swells as more lithium is added to it. Swelling is a problem in most cases. Anode region 108 shrinks during discharge state.

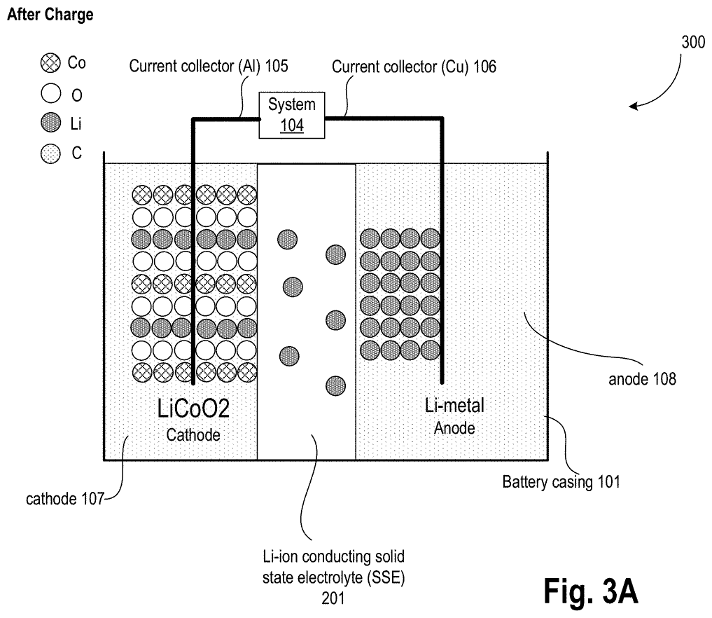

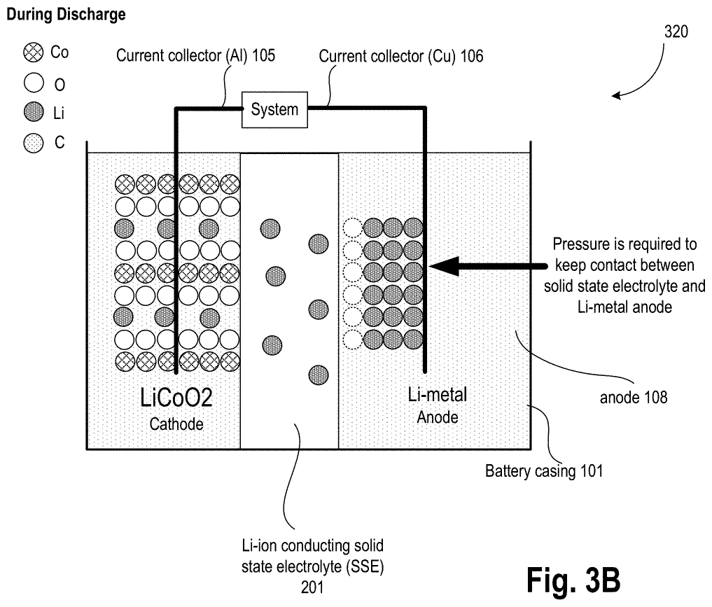

FIGS. 3A-B illustrate cross-sectional views of Li-metal rechargeable battery 300, 320 in charged state and during discharge state, respectively. After charge, anode region 108 is fully swelled as shown in FIG. 3A. During discharge, Li-ion moves back to cathode region 107. However, only surface Li that has contact with solid state electrolyte 201 moves and other Li does not react due to no contact with electrolyte 201.

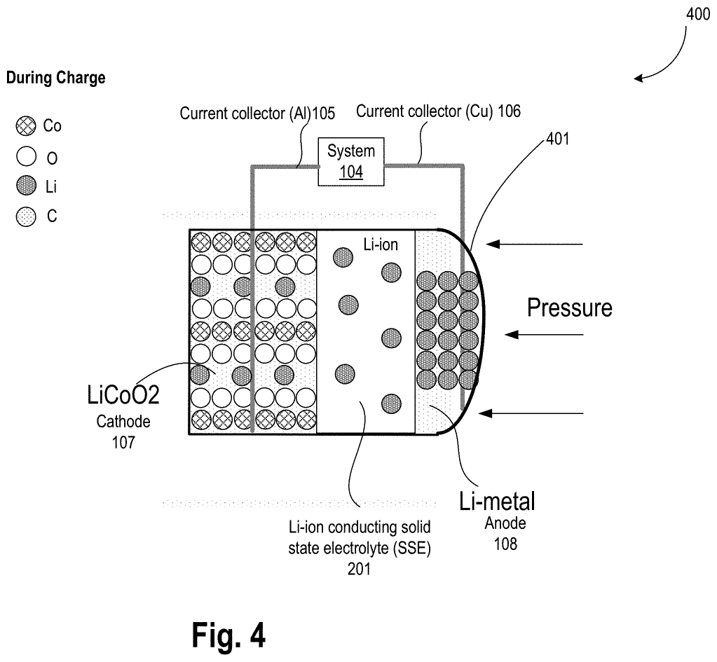

FIG. 4 illustrates a cross-sectional view of typical packaging system 400. To keep anode-electrolyte contact, thick (e.g., greater than 6 mm) enclosure 401 may be used so that it gives pressure (e.g. 0.2 MPa) after battery is charged and swelled as showing in FIG. 4. However, this does not give uniform pressure to anode 108, causes electrode deformation (as shown by the concave shaped enclosure 401) and results in poor cycle life.

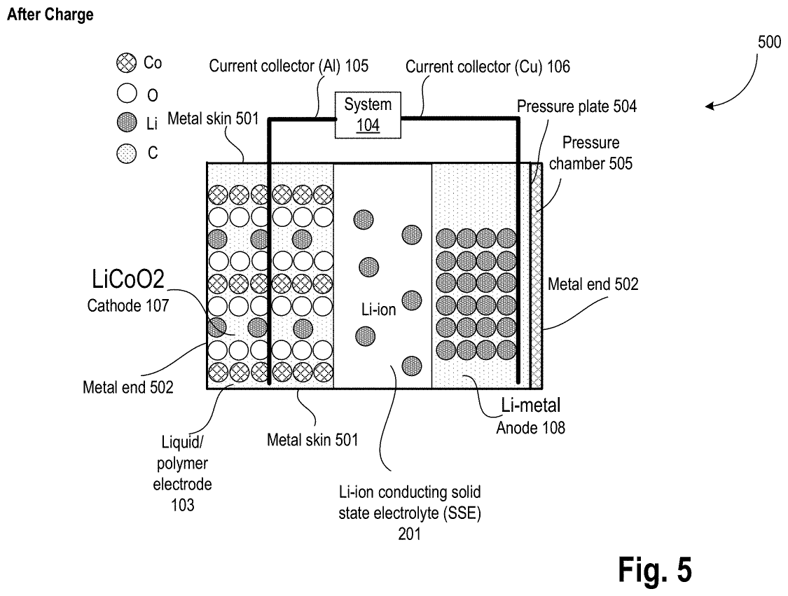

FIG. 5 illustrates a cross-sectional view of a packaging system 500 with pressure chamber, in accordance with some embodiments. Packaging system 500 includes battery casing or housing comprising metal skin 501 and metal ends 502. The materials for metal skin 501 and metal ends 502 can be the same. Material for metal skin 501 and metal ends 502 include one or more of: stainless steel, copper, aluminum or brass; or cast/forged such as zinc, magnesium or aluminum blend. Material for metal skin 501 and metal ends 502 may also include non-metallic material such as fiber reinforced plastic or ceramic. The housing contains cathode region 107, anode region 108, and separation region 201. Metal skin 501 encases portions of cathode region 107, anode region 108, and separation region 201. Metal ends 502 secure the ends of the battery which are pressure chamber 504 and barrier of cathode region 107.

The cross-sectional view shows a pressure equalization plate 504 and a pressure chamber 505. In some embodiments, pressure chamber includes a valve for gas injection. Pressure chamber 505 gives uniform pressure to the battery through pressure equalization plate 504. Pressure chamber 505 is supported by metal ends 502 connected with metal skins 501 to give uniform pressure to battery. Metal skins 501 also work to prevent battery from deformation under pressure. In some embodiments, the thickness of metal skin 501 and/or metal ends 502 along the x-axis is in a range of 0.05 mm to 1.0 mm.

In some embodiments, pressure chamber 505 may be a chamber that includes pressured gas, elastic material, elastic foam, spring plate, pressured liquid, expandable material; mechanical spring. The valve van be used to inject pressured gas, elastic material, elastic foam, pressured liquid, and/or expandable material. The pressurized material in pressure chamber 505 is gas such as air or nitrogen; elastic material such as rubber or rubber-like; foam such as rubber or polymer foam, or sponge; liquid such as water or glycerin; or expandable material such as polymer or graphite-based materials. In various embodiments, pressure chamber 505 is designed to handle a pressure in a range of 0.5 atm to 10.0 atm (0.05 MPa to 1 MPa).

In one example, pressure chamber 505 is capable of handling substantially 0.2M MPa. In some embodiments, the expandable material is such that when the battery is manufactured in cold temperature (e.g., less than 5 degrees C.), the expandable material produces pressure at ambient temperature or at normal use time. In some embodiments, pressure chamber 505 may include valve(s) for gas injection. In some embodiments, contact to battery cathode/anode terminals or current collects (105, 106) may be established through metal plates, metal ends, and/or metal valve(s) to pressure chamber 505. In some embodiments, pressure chamber 505 may be placed not only on one side but also multiple sides of the battery. In some embodiments, pressure chamber 505 or a part of chamber 505 is integrated in other structural parts, such as chassis or cover. The pressure might be produced by utilizing thermal expansion. For example, the chamber is assembled in low temperature and the pressure is generated when the pressure material is expanding in ambient temperature.

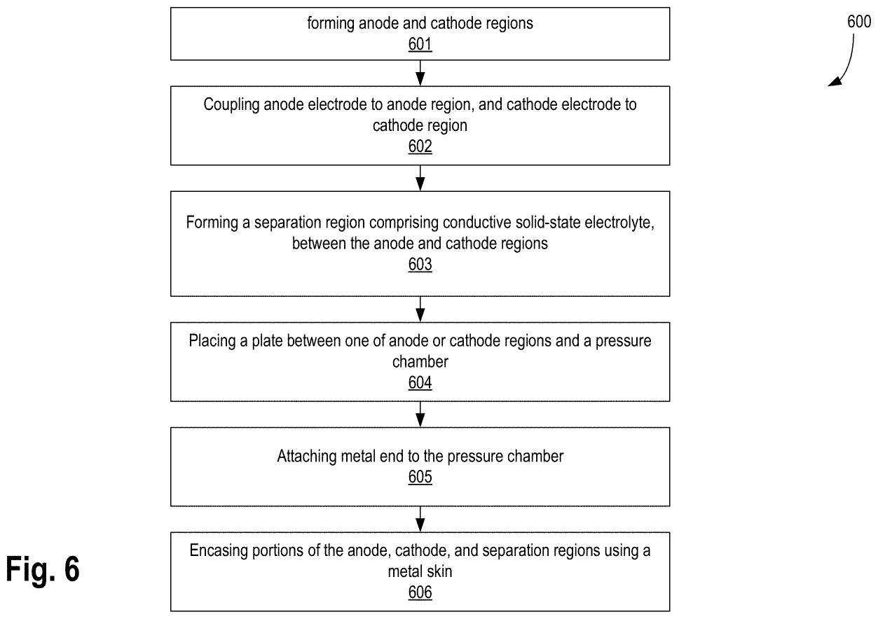

FIG. 6 illustrates flowchart 600 of a method of forming a Li-metal battery with pressure chamber to apply uniform pressure to the battery, in accordance with some embodiments. While various blocks are shown in a particular order, the order can be modified. For example, some blocks can be performed before others, while some blocks can be performed in parallel.

At block 601, cathode and anode regions (107, 108) are formed. Prior to forming these regions, a battery casing (e.g., metal skin 501) may be formed to hold the anode and cathode regions. In some embodiments, the cathode region includes one of Li, Co, Ni, Mn, Fe, Al, P or O. In some embodiments, the anode region includes one of Li-metal and Si. At block 602, respective current collectors are connected to the two regions. For example, cathode current collector 105 (e.g., Al) is coupled to cathode region 107 while anode current collector 106 (e.g., Cu) is coupled to anode region 108. At block 603, separation region 201 is formed between cathode and anode regions (107, 108). In some embodiments, when separation region 201 is formed in a battery casing, the remainder regions are designated as cathode and anode regions. Separation region 201 can be conductive solid-state electrolyte. At block 604, pressure plate 504 is connected or formed adjacent to the anode region 108. Pressure plate 504 can be formed adjacent to other outer regions of the battery that are expected to expand or shrink, for example.

Pressure chamber 505 is formed and placed adjacent to the pressure plate 504. In some embodiments, pressure chamber 505 includes one of: pressured gas, elastic material, elastic foam, spring plate, pressured liquid, deformed metal, expandable material; mechanical spring. One purpose of the pressure chamber is to apply uniform pressure to pressure plate 504 that preserves the integrity of the battery during charging and discharging. At block 605, metal ends 502 are secured to pressure chamber 505. At block 606, the entire battery is encased in metal skin 501 to protect the inner connects of the battery and provide the battery an expected dimension.

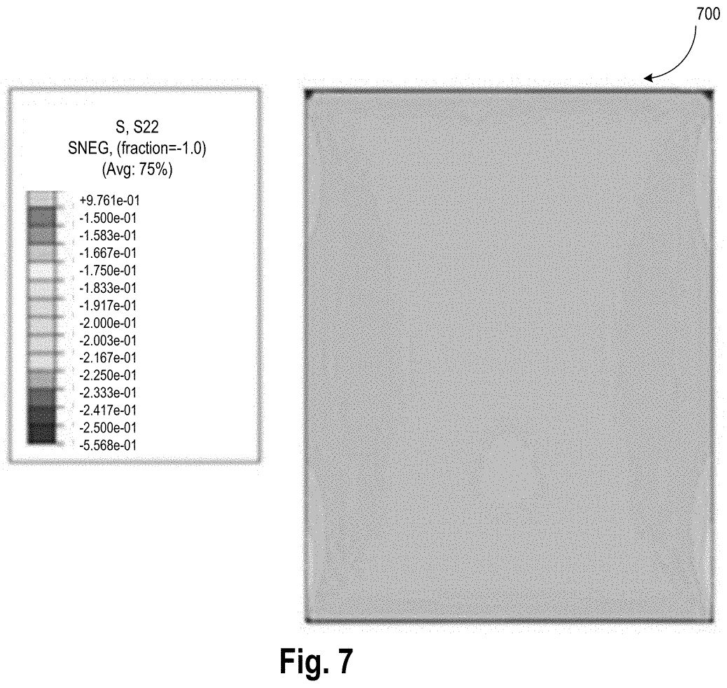

FIG. 7 illustrates plot 700 showing simulation result of pressure distribution when 0.2 MPa is applied from the pressure chamber on the top of the cell, in accordance with some embodiments. The simulation result of pressure distribution shows pressure chamber is placed on the top of the cell (e.g., 60 mm-wide and 80 mm-high), metal ends are place on the top and bottom and metal skins are on the sides. Thickness of each component are: Metal end: 0.4 mm×2; Pressure chamber: 1.05 mm; Pressure equalization plate: 0.5 mm; and Metal skin: 0.1 mm×2. In this case, cathode/anode electrodes are stacked from top to bottom and 0.2 MPa is applied from top to bottom by pressure chamber. As the simulation result shows, pressure is applied to entire battery uniformly.

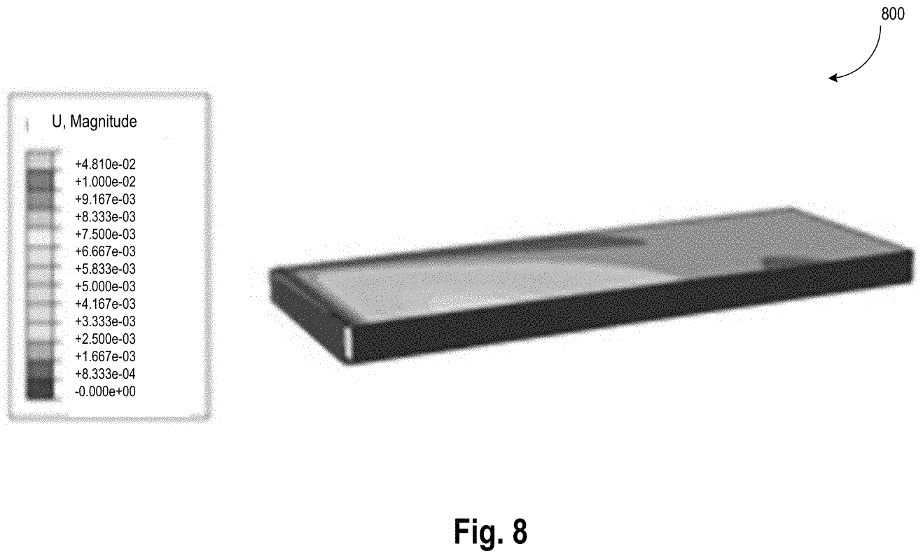

FIG. 8 illustrates cross-sectional simulation result 800 of battery displacements when 0.2 MPa is applied from pressure chamber on the left of the cell, in accordance with some embodiments. FIG. 8 shows displacements of the cross section in the same battery structure. The pressure chamber is seen in the left end. The maximum metal skin deflections by the pressure are less than 10 μm, which is negligible.

The embodiments of this invention may take some space from a system but is offset by making chassis material thinner without impact on mechanical strength. In case of 4×60×80 mm battery cell, volume difference without this structure and with this structure is 3%. As this structure enables Li-metal rechargeable battery which gives better energy density (e.g., greater than 20%) total increase of battery life with this structure is high (e.g., greater than 16%)

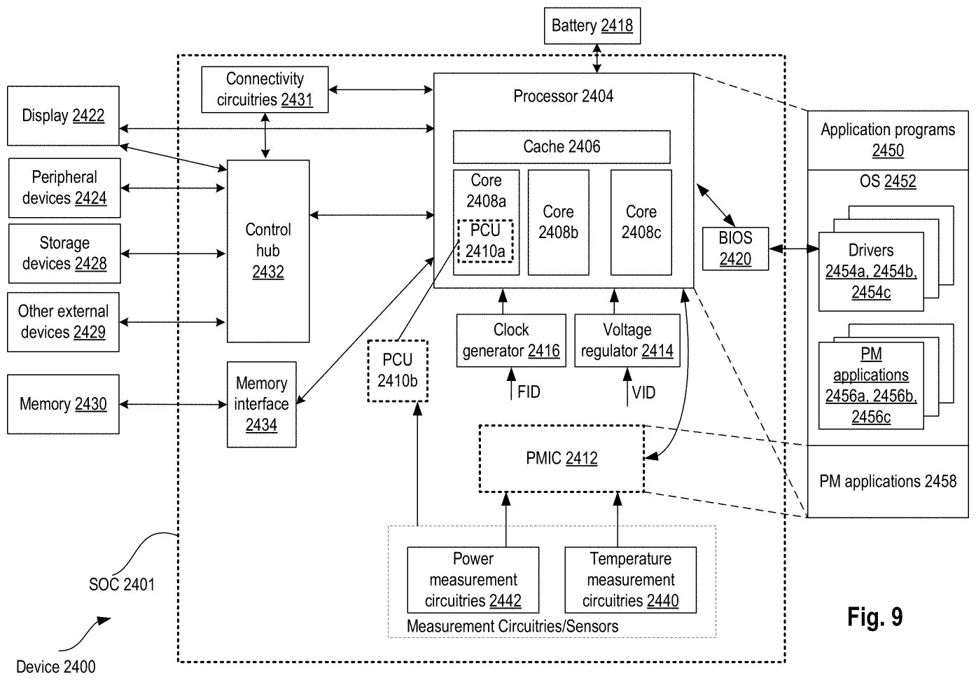

FIG. 9 illustrates a smart device or a computer system or a SoC (System-on-Chip) powered by a Li-ion battery of some embodiments. It is pointed out that those elements of FIG. 9 having the same reference numbers (or names) as the elements of any other figure may operate or function in any manner similar to that described, but are not limited to such.

In some embodiments, device 2400 represents an appropriate computing device, such as a computing tablet, a mobile phone or smart-phone, a laptop, a desktop, an Internet-of-Things (IOT) device, a server, a wearable device, a set-top box, a wireless-enabled e-reader, or the like. It will be understood that certain components are shown generally, and not all components of such a device are shown in device 2400.

In an example, the device 2400 comprises an SoC (System-on-Chip) 2401. An example boundary of the SOC 2401 is illustrated using dotted lines in FIG. 9, with some example components being illustrated to be included within SOC 2401—however, SOC 2401 may include any appropriate components of device 2400.

In some embodiments, device 2400 includes processor 2404. Processor 2404 can include one or more physical devices, such as microprocessors, application processors, microcontrollers, programmable logic devices, processing cores, or other processing means. The processing operations performed by processor 2404 include the execution of an operating platform or operating system on which applications and/or device functions are executed. The processing operations include operations related to I/O (input/output) with a human user or with other devices, operations related to power management, operations related to connecting computing device 2400 to another device, and/or the like. The processing operations may also include operations related to audio I/O and/or display I/O.

In some embodiments, processor 2404 includes multiple processing cores (also referred to as cores) 2408a, 2408b, 2408c. Although merely three cores 2408a, 2408b, 2408c are illustrated in FIG. 9, processor 2404 may include any other appropriate number of processing cores, e.g., tens, or even hundreds of processing cores. Processor cores 2408a, 2408b, 2408c may be implemented on a single integrated circuit (IC) chip. Moreover, the chip may include one or more shared and/or private caches, buses or interconnections, graphics and/or memory controllers, or other components.

In some embodiments, processor 2404 includes cache 2406. In an example, sections of cache 2406 may be dedicated to individual cores 2408 (e.g., a first section of cache 2406 dedicated to core 2408a, a second section of cache 2406 dedicated to core 2408b, and so on). In an example, one or more sections of cache 2406 may be shared among two or more of cores 2408. Cache 2406 may be split in different levels, e.g., level 1 (L1) cache, level 2 (L2) cache, level 3 (L3) cache, etc.

In some embodiments, processor core 2404 may include a fetch unit to fetch instructions (including instructions with conditional branches) for execution by the core 2404. The instructions may be fetched from any storage devices such as the memory 2430. Processor core 2404 may also include a decode unit to decode the fetched instruction. For example, the decode unit may decode the fetched instruction into a plurality of micro-operations. Processor core 2404 may include a schedule unit to perform various operations associated with storing decoded instructions. For example, the schedule unit may hold data from the decode unit until the instructions are ready for dispatch, e.g., until all source values of a decoded instruction become available. In one embodiment, the schedule unit may schedule and/or issue (or dispatch) decoded instructions to an execution unit for execution.

The execution unit may execute the dispatched instructions after they are decoded (e.g., by the decode unit) and dispatched (e.g., by the schedule unit). In an embodiment, the execution unit may include more than one execution unit (such as an imaging computational unit, a graphics computational unit, a general-purpose computational unit, etc.). The execution unit may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit.

Further, execution unit may execute instructions out-of-order. Hence, processor core 2404 may be an out-of-order processor core in one embodiment. Processor core 2404 may also include a retirement unit. The retirement unit may retire executed instructions after they are committed. In an embodiment, retirement of the executed instructions may result in processor state being committed from the execution of the instructions, physical registers used by the instructions being de-allocated, etc. Processor core 2404 may also include a bus unit to enable communication between components of processor core 2404 and other components via one or more buses. Processor core 2404 may also include one or more registers to store data accessed by various components of the core 2404 (such as values related to assigned app priorities and/or sub-system states (modes) association.

In some embodiments, device 2400 comprises connectivity circuitries 2431. For example, connectivity circuitries 2431 includes hardware devices (e.g., wireless and/or wired connectors and communication hardware) and/or software components (e.g., drivers, protocol stacks), e.g., to enable device 2400 to communicate with external devices. Device 2400 may be separate from the external devices, such as other computing devices, wireless access points or base stations, etc.

In an example, connectivity circuitries 2431 may include multiple different types of connectivity. To generalize, the connectivity circuitries 2431 may include cellular connectivity circuitries, wireless connectivity circuitries, etc. Cellular connectivity circuitries of connectivity circuitries 2431 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, 3rd Generation Partnership Project (3GPP) Universal Mobile Telecommunications Systems (UMTS) system or variations or derivatives, 3GPP Long-Term Evolution (LTE) system or variations or derivatives, 3GPP LTE-Advanced (LTE-A) system or variations or derivatives, Fifth Generation (5G) wireless system or variations or derivatives, 5G mobile networks system or variations or derivatives, 5G New Radio (NR) system or variations or derivatives, or other cellular service standards. Wireless connectivity circuitries (or wireless interface) of the connectivity circuitries 2431 refers to wireless connectivity that is not cellular, and can include personal area networks (such as Bluetooth, Near Field, etc.), local area networks (such as Wi-Fi), and/or wide area networks (such as WiMax), and/or other wireless communication. In an example, connectivity circuitries 2431 may include a network interface, such as a wired or wireless interface, e.g., so that a system embodiment may be incorporated into a wireless device, for example, a cell phone or personal digital assistant.

In some embodiments, device 2400 comprises control hub 2432, which represents hardware devices and/or software components related to interaction with one or more I/O devices. For example, processor 2404 may communicate with one or more of display 2422, one or more peripheral devices 2424, storage devices 2428, one or more other external devices 2429, etc., via control hub 2432. Control hub 2432 may be a chipset, a Platform Control Hub (PCH), and/or the like.

For example, control hub 2432 illustrates one or more connection points for additional devices that connect to device 2400, e.g., through which a user might interact with the system. For example, devices (e.g., devices 2429) that can be attached to device 2400 include microphone devices, speaker or stereo systems, audio devices, video systems or other display devices, keyboard or keypad devices, or other I/O devices for use with specific applications such as card readers or other devices.

As mentioned above, control hub 2432 can interact with audio devices, display 2422, etc. For example, input through a microphone or other audio device can provide input or commands for one or more applications or functions of device 2400. Additionally, audio output can be provided instead of, or in addition to display output. In another example, if display 2422 includes a touch screen, display 2422 also acts as an input device, which can be at least partially managed by control hub 2432. There can also be additional buttons or switches on computing device 2400 to provide I/O functions managed by control hub 2432. In one embodiment, control hub 2432 manages devices such as accelerometers, cameras, light sensors or other environmental sensors, or other hardware that can be included in device 2400. The input can be part of direct user interaction, as well as providing environmental input to the system to influence its operations (such as filtering for noise, adjusting displays for brightness detection, applying a flash for a camera, or other features).

In some embodiments, control hub 2432 may couple to various devices using any appropriate communication protocol, e.g., PCIe (Peripheral Component Interconnect Express), USB (Universal Serial Bus), Thunderbolt, High Definition Multimedia Interface (HDMI), Firewire, etc.

In some embodiments, display 2422 represents hardware (e.g., display devices) and software (e.g., drivers) components that provide a visual and/or tactile display for a user to interact with device 2400. Display 2422 may include a display interface, a display screen, and/or hardware device used to provide a display to a user. In some embodiments, display 2422 includes a touch screen (or touch pad) device that provides both output and input to a user. In an example, display 2422 may communicate directly with the processor 2404. Display 2422 can be one or more of an internal display device, as in a mobile electronic device or a laptop device or an external display device attached via a display interface (e.g., DisplayPort, etc.). In one embodiment display 2422 can be a head mounted display (HMD) such as a stereoscopic display device for use in virtual reality (VR) applications or augmented reality (AR) applications.

In some embodiments, and although not illustrated in the figure, in addition to (or instead of) processor 2404, device 2400 may include Graphics Processing Unit (GPU) comprising one or more graphics processing cores, which may control one or more aspects of displaying contents on display 2422.

Control hub 2432 (or platform controller hub) may include hardware interfaces and connectors, as well as software components (e.g., drivers, protocol stacks) to make peripheral connections, e.g., to peripheral devices 2424.

It will be understood that device 2400 could both be a peripheral device to other computing devices, as well as have peripheral devices connected to it. Device 2400 may have a “docking” connector to connect to other computing devices for purposes such as managing (e.g., downloading and/or uploading, changing, synchronizing) content on device 2400. Additionally, a docking connector can allow device 2400 to connect to certain peripherals that allow computing device 2400 to control content output, for example, to audiovisual or other systems.

In addition to a proprietary docking connector or other proprietary connection hardware, device 2400 can make peripheral connections via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, connectivity circuitries 2431 may be coupled to control hub 2432, e.g., in addition to, or instead of, being coupled directly to the processor 2404. In some embodiments, display 2422 may be coupled to control hub 2432, e.g., in addition to, or instead of, being coupled directly to processor 2404.

In some embodiments, device 2400 comprises memory 2430 coupled to processor 2404 via memory interface 2434. Memory 2430 includes memory devices for storing information in device 2400.

In some embodiments, memory 2430 includes apparatus to maintain stable clocking as described with reference to various embodiments. Memory can include nonvolatile (state does not change if power to the memory device is interrupted) and/or volatile (state is indeterminate if power to the memory device is interrupted) memory devices. Memory device 2430 can be a dynamic random-access memory (DRAM) device, a static random-access memory (SRAM) device, flash memory device, phase-change memory device, or some other memory device having suitable performance to serve as process memory. In one embodiment, memory 2430 can operate as system memory for device 2400, to store data and instructions for use when the one or more processors 2404 executes an application or process. Memory 2430 can store application data, user data, music, photos, documents, or other data, as well as system data (whether long-term or temporary) related to the execution of the applications and functions of device 2400.

Elements of various embodiments and examples are also provided as a machine-readable medium (e.g., memory 2430) for storing the computer-executable instructions (e.g., instructions to implement any other processes discussed herein). The machine-readable medium (e.g., memory 2430) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

In some embodiments, device 2400 comprises temperature measurement circuitries 2440, e.g., for measuring temperature of various components of device 2400. In an example, temperature measurement circuitries 2440 may be embedded, or coupled or attached to various components, whose temperature are to be measured and monitored. For example, temperature measurement circuitries 2440 may measure temperature of (or within) one or more of cores 2408a, 2408b, 2408c, voltage regulator 2414, memory 2430, a motherboard of SOC 2401, and/or any appropriate component of device 2400.

In some embodiments, device 2400 comprises power measurement circuitries 2442, e.g., for measuring power consumed by one or more components of the device 2400. In an example, in addition to, or instead of, measuring power, the power measurement circuitries 2442 may measure voltage and/or current. In an example, the power measurement circuitries 2442 may be embedded, or coupled or attached to various components, whose power, voltage, and/or current consumption are to be measured and monitored. For example, power measurement circuitries 2442 may measure power, current and/or voltage supplied by one or more voltage regulators 2414, power supplied to SOC 2401, power supplied to device 2400, power consumed by processor 2404 (or any other component) of device 2400, etc.

In some embodiments, device 2400 comprises one or more voltage regulator circuitries, generally referred to as voltage regulator (VR) 2414. VR 2414 generates signals at appropriate voltage levels, which may be supplied to operate any appropriate components of the device 2400. Merely as an example, VR 2414 is illustrated to be supplying signals to processor 2404 of device 2400. In some embodiments, VR 2414 receives one or more Voltage Identification (VID) signals, and generates the voltage signal at an appropriate level, based on the VID signals. Various type of VRs may be utilized for the VR 2414. For example, VR 2414 may include a “buck” VR, “boost” VR, a combination of buck and boost VRs, low dropout (LDO) regulators, switching DC-DC regulators, constant-on-time controller-based DC-DC regulator, etc. Buck VR is generally used in power delivery applications in which an input voltage needs to be transformed to an output voltage in a ratio that is smaller than unity. Boost VR is generally used in power delivery applications in which an input voltage needs to be transformed to an output voltage in a ratio that is larger than unity. In some embodiments, each processor core has its own VR, which is controlled by PCU 2410a/b and/or PMIC 2412. In some embodiments, each core has a network of distributed LDOs to provide efficient control for power management. The LDOs can be digital, analog, or a combination of digital or analog LDOs. In some embodiments, VR 2414 includes current tracking apparatus to measure current through power supply rail(s).

In some embodiments, device 2400 comprises one or more clock generator circuitries, generally referred to as clock generator 2416. Clock generator 2416 generates clock signals at appropriate frequency levels, which may be supplied to any appropriate components of device 2400. Merely as an example, clock generator 2416 is illustrated to be supplying clock signals to processor 2404 of device 2400. In some embodiments, clock generator 2416 receives one or more Frequency Identification (FID) signals, and generates the clock signals at an appropriate frequency, based on the FID signals.

In some embodiments, device 2400 comprises battery 2418 supplying power to various components of device 2400. Merely as an example, battery 2418 is illustrated to be supplying power to processor 2404. Although not illustrated in the figures, device 2400 may comprise a charging circuitry, e.g., to recharge the battery, based on Alternating Current (AC) power supply received from an AC adapter.

In some embodiments, device 2400 comprises Power Control Unit (PCU) 2410 (also referred to as Power Management Unit (PMU), Power Controller, etc.). In an example, some sections of PCU 2410 may be implemented by one or more processing cores 2408, and these sections of PCU 2410 are symbolically illustrated using a dotted box and labelled PCU 2410a. In an example, some other sections of PCU 2410 may be implemented outside the processing cores 2408, and these sections of PCU 2410 are symbolically illustrated using a dotted box and labelled as PCU 2410b. PCU 2410 may implement various power management operations for device 2400. PCU 2410 may include hardware interfaces, hardware circuitries, connectors, registers, etc., as well as software components (e.g., drivers, protocol stacks), to implement various power management operations for device 2400.

In some embodiments, device 2400 comprises Power Management Integrated Circuit (PMIC) 2412, e.g., to implement various power management operations for device 2400. In some embodiments, PMIC 2412 is a Reconfigurable Power Management ICs (RPMICs) and/or an IMVP (Intel® Mobile Voltage Positioning). In an example, the PMIC is within an IC chip separate from processor 2404. The may implement various power management operations for device 2400. PMIC 2412 may include hardware interfaces, hardware circuitries, connectors, registers, etc., as well as software components (e.g., drivers, protocol stacks), to implement various power management operations for device 2400.

In an example, device 2400 comprises one or both PCU 2410 or PMIC 2412. In an example, any one of PCU 2410 or PMIC 2412 may be absent in device 2400, and hence, these components are illustrated using dotted lines.

Various power management operations of device 2400 may be performed by PCU 2410, by PMIC 2412, or by a combination of PCU 2410 and PMIC 2412. For example, PCU 2410 and/or PMIC 2412 may select a power state (e.g., P-state) for various components of device 2400. For example, PCU 2410 and/or PMIC 2412 may select a power state (e.g., in accordance with the ACPI (Advanced Configuration and Power Interface) specification) for various components of device 2400. Merely as an example, PCU 2410 and/or PMIC 2412 may cause various components of the device 2400 to transition to a sleep state, to an active state, to an appropriate C state (e.g., C0 state, or another appropriate C state, in accordance with the ACPI specification), etc. In an example, PCU 2410 and/or PMIC 2412 may control a voltage output by VR 2414 and/or a frequency of a clock signal output by the clock generator, e.g., by outputting the VID signal and/or the FID signal, respectively. In an example, PCU 2410 and/or PMIC 2412 may control battery power usage, charging of battery 2418, and features related to power saving operation.

The clock generator 2416 can comprise a phase locked loop (PLL), frequency locked loop (FLL), or any suitable clock source. In some embodiments, each core of processor 2404 has its own clock source. As such, each core can operate at a frequency independent of the frequency of operation of the other core. In some embodiments, PCU 2410 and/or PMIC 2412 performs adaptive or dynamic frequency scaling or adjustment. For example, clock frequency of a processor core can be increased if the core is not operating at its maximum power consumption threshold or limit. In some embodiments, PCU 2410 and/or PMIC 2412 determines the operating condition of each core of a processor, and opportunistically adjusts frequency and/or power supply voltage of that core without the core clocking source (e.g., PLL of that core) losing lock when the PCU 2410 and/or PMIC 2412 determines that the core is operating below a target performance level. For example, if a core is drawing current from a power supply rail less than a total current allocated for that core or processor 2404, then PCU 2410 and/or PMIC 2412 can temporality increase the power draw for that core or processor 2404 (e.g., by increasing clock frequency and/or power supply voltage level) so that the core or processor 2404 can perform at higher performance level. As such, voltage and/or frequency can be increased temporality for processor 2404 without violating product reliability.

In an example, PCU 2410 and/or PMIC 2412 may perform power management operations, e.g., based at least in part on receiving measurements from power measurement circuitries 2442, temperature measurement circuitries 2440, charge level of battery 2418, and/or any other appropriate information that may be used for power management. To that end, PMIC 2412 is communicatively coupled to one or more sensors to sense/detect various values/variations in one or more factors having an effect on power/thermal behavior of the system/platform. Examples of the one or more factors include electrical current, voltage droop, temperature, operating frequency, operating voltage, power consumption, inter-core communication activity, etc. One or more of these sensors may be provided in physical proximity (and/or thermal contact/coupling) with one or more components or logic/IP blocks of a computing system. Additionally, sensor(s) may be directly coupled to PCU 2410 and/or PMIC 2412 in at least one embodiment to allow PCU 2410 and/or PMIC 2412 to manage processor core energy at least in part based on value(s) detected by one or more of the sensors.

Also illustrated is an example software stack of device 2400 (although not all elements of the software stack are illustrated). Merely as an example, processors 2404 may execute application programs 2450, Operating System 2452, one or more Power Management (PM) specific application programs (e.g., generically referred to as PM applications 2458), and/or the like. PM applications 2458 may also be executed by the PCU 2410 and/or PMIC 2412. OS 2452 may also include one or more PM applications 2456a, 2456b, 2456c. The OS 2452 may also include various drivers 2454a, 2454b, 2454c, etc., some of which may be specific for power management purposes. In some embodiments, device 2400 may further comprise a Basic Input/output System (BIOS) 2420. BIOS 2420 may communicate with OS 2452 (e.g., via one or more drivers 2454), communicate with processors 2404, etc.

For example, one or more of PM applications 2458, 2456, drivers 2454, BIOS 2420, etc. may be used to implement power management specific tasks, e.g., to control voltage and/or frequency of various components of device 2400, to control wake-up state, sleep state, and/or any other appropriate power state of various components of device 2400, control battery power usage, charging of the battery 2418, features related to power saving operation, etc.

In some embodiments, battery 2418 is a Li-metal battery with a pressure chamber to allow uniform pressure on a battery. The pressure chamber is supported by metal plates (such as pressure equalization plate) used to give uniform pressure to the battery. The pressure chamber may include pressured gas, elastic material, spring plate, etc. The outer skin of the pressure chamber is free to bow, restrained at its edges by (metal) skin, but still exerts a uniform pressure on the plate that is compressing the battery cell. The pressure chamber gives uniform pressure to battery, which is used to enable high-energy density battery with, for example, 20% more battery life.

In some embodiments, pCode executing on PCU 2410a/b has a capability to enable extra compute and telemetries resources for the runtime support of the pCode. Here pCode refers to a firmware executed by PCU 2410a/b to manage performance of the 2401. For example, pCode may set frequencies and appropriate voltages for the processor. Part of the pCode are accessible via OS 2452. In various embodiments, mechanisms and methods are provided that dynamically change an Energy Performance Preference (EPP) value based on workloads, user behavior, and/or system conditions. There may be a well-defined interface between OS 2452 and the pCode. The interface may allow or facilitate the software configuration of several parameters and/or may provide hints to the pCode. As an example, an EPP parameter may inform a pCode algorithm as to whether performance or battery life is more important.

This support may be done as well by the OS 2452 by including machine-learning support as part of OS 2452 and either tuning the EPP value that the OS hints to the hardware (e.g., various components of SCO 2401) by machine-learning prediction, or by delivering the machine-learning prediction to the pCode in a manner similar to that done by a Dynamic Tuning Technology (DTT) driver. In this model, OS 2452 may have visibility to the same set of telemetries as are available to a DTT. As a result of a DTT machine-learning hint setting, pCode may tune its internal algorithms to achieve optimal power and performance results following the machine-learning prediction of activation type. The pCode as example may increase the responsibility for the processor utilization change to enable fast response for user activity, or may increase the bias for energy saving either by reducing the responsibility for the processor utilization or by saving more power and increasing the performance lost by tuning the energy saving optimization. This approach may facilitate saving more battery life in case the types of activities enabled lose some performance level over what the system can enable. The pCode may include an algorithm for dynamic EPP that may take the two inputs, one from OS 2452 and the other from software such as DTT, and may selectively choose to provide higher performance and/or responsiveness. As part of this method, the pCode may enable in the DTT an option to tune its reaction for the DTT for different types of activity.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process. The examples can be combined in any combinations. For example, example 4 can be combined with example 2.

Example 1: A battery comprising: an anode region; a cathode region; a separation region between the anode and cathode regions, wherein the separation regions include conductive solid-state electrolyte; a pressure chamber; and a plate between one of the anode or cathode regions and the pressure chamber.

Example 2: The battery of example 1, wherein the plate is to provide equalized pressure to a housing containing the anode, cathode, and separation regions.

Example 3: The battery of example 1 comprises metal end attached to the pressure chamber.

Example 4: The battery of example 1 comprises metal skin to encase portions of the anode, cathode, and separation regions, wherein the metal skin is coupled to the plate.

Example 5: The battery of example 1, wherein the pressure chamber includes one of: pressured gas, elastic material, elastic foam, spring plate, pressured liquid, deformed metal, expandable material; or mechanical spring.

Example 6: The battery of example 1, wherein the pressure chamber includes valve for gas injection.

Example 7: The battery of example 1, wherein the conductive solid-state electrolyte comprises Li-ion.

Example 8: The battery of example 1, wherein the cathode region includes one of Li, Co, Ni, Mn, Fe, Al, P, or O.

Example 9: The battery of example 1, wherein the anode region includes one of Li-metal and Si.

Example 10: A method comprising: forming an anode region; forming a cathode region; forming a separation region between the anode and cathode regions, wherein the separation regions include conductive solid-state electrolyte; forming a pressure chamber; and placing a plate between one of the anode or cathode regions and the pressure chamber.

Example 11: The method of example 10 comprises providing, via the plate, equalized pressure to a housing containing the anode, cathode, and separation regions.

Example 12: The method of example 10 comprises attaching a metal end to the pressure chamber.

Example 13: The method of example 10 comprises encasing, via metal skin, portions of the anode, cathode, and separation regions.

Example 14: The method of example 10, wherein the pressure chamber includes one of: pressured gas, elastic material, elastic foam, spring plate, pressured liquid, deformed metal, expandable material, or mechanical spring.

Example 15: The method of example 10, wherein the pressure chamber includes valve for gas injection.

Example 16: The method of example 10, wherein the conductive solid-state electrolyte comprises Li-ion.

Example 17: The method of example 10, wherein the cathode region includes one of Li, Co, Ni, Mn, Fe, Al, P, or O.

Example 18: The method of example 10, wherein the anode region includes one of Li-metal and Si.

Example 19: A system comprising: a memory; a processor coupled to the memory; and a battery to power the processor and the memory, wherein the battery includes: an anode region; a cathode region; a separation region between the anode and cathode regions, wherein the separation regions include conductive solid-state electrolyte; a pressure chamber; and a plate between one of the anode or cathode regions and the pressure chamber.

Example 20: The system of example 19, wherein: the plate is to provide equalized pressure to a housing containing the anode, cathode, and separation regions; the pressure chamber includes one of: pressured gas, elastic material, elastic foam, spring plate, pressured liquid, deformed metal, expandable material, or mechanical spring; the pressure chamber includes valve for gas injection; the conductive solid-state electrolyte comprises Li-ion; the cathode region includes one of Li, Co, Ni, Mn, Fe, Al, P or O; and the anode region includes one of Li-metal and Si.

Example 21: The system of example 20, wherein the battery comprises: metal end attached to the pressure chamber; and metal skin to encase portions of the anode, cathode, and separation regions, wherein the metal skin is coupled to the plate.

Example 22: A battery comprising: a pressure plate; a pressure chamber adjacent to the pressure plate; and an anode region adjacent to the pressure plate, wherein the pressure chamber is to apply a pressure in a range of 0.05 MPa to 1 MPa.

Example 23: The battery of example 22, wherein the anode region includes one of Li-metal and Si.

Example 24: The battery of example 23 comprises: a cathode region; and a separation region between the anode and cathode regions, wherein the separation regions include conductive solid-state electrolyte.

Example 25: The battery of example 24, wherein the pressure plate is to provide equalized pressure to a housing containing the anode, cathode, and separation regions.

Example 26: The battery of example 24 comprises metal skin to encase portions of the anode, cathode, and separation regions, wherein the metal skin is coupled to the pressure plate.

Example 27: The battery of example 22, wherein the pressure chamber includes one of: pressured gas, elastic material, elastic foam, spring plate, pressured liquid, deformed metal, expandable material; or mechanical spring.

Example 28: The battery of example 22 comprises metal end attached to the pressure chamber.

Example 29: The battery of example 22, wherein the pressure chamber includes valve for gas injection.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. A battery comprising:
an anode region;
a cathode region;
a separation region between the anode and cathode regions, wherein the separation region includes conductive solid-state electrolyte;
a pressure chamber; and
a plate between one of the anode or cathode regions and the pressure chamber.

2. The battery of claim 1, wherein the plate is to provide equalized pressure to a housing containing the anode, cathode, and separation regions.

3. The battery of claim 1 comprises metal end attached to the pressure chamber.

4. The battery of claim 1 comprises metal skin to encase portions of the anode, cathode, and separation regions, wherein the metal skin is coupled to the plate.

5. The battery of claim 1, wherein the pressure chamber includes one of: pressured gas, elastic material, elastic foam, spring plate, pressured liquid, deformed metal, expandable material; or mechanical spring.

6. The battery of claim 1, wherein the pressure chamber includes valve for gas injection.

7. The battery of claim 1, wherein the conductive solid-state electrolyte comprises Li-ion.

8. The battery of claim 1, wherein the cathode region includes one of Li, Co, Ni, Mn, Fe, Al, P, or O.

9. The battery of claim 1, wherein the anode region includes one of Li-metal and Si.

10. A battery comprising:
a pressure plate;
a pressure chamber adjacent to the pressure plate; and
an anode region adjacent to the pressure plate, wherein the pressure chamber is to apply a pressure in a range of 0.05 MPa to 1 MPa.

11. The battery of claim 10, wherein the anode region includes one of Li-metal and Si.

12. The battery of claim 10 comprises:
a cathode region; and
a separation region between the anode and cathode regions, wherein the separation region includes conductive solid-state electrolyte.

13. The battery of claim 12, wherein the pressure plate is to provide equalized pressure to a housing containing the anode, cathode, and separation regions.

14. The battery of claim 12 comprises metal skin to encase portions of the anode, cathode, and separation regions, wherein the metal skin is coupled to the pressure plate.

15. The battery of claim 10, wherein the pressure chamber includes one of: pressured gas, elastic material, elastic foam, spring plate, pressured liquid, deformed metal, expandable material; or mechanical spring.

16. The battery of claim 10 comprises metal end attached to the pressure chamber.

17. The battery of claim 10, wherein the pressure chamber includes valve for gas injection.

18. A system comprising:
a memory;
a processor coupled to the memory; and
a battery to power the processor and the memory, wherein the battery includes:
an anode region;
a cathode region;
a separation region between the anode and cathode regions, wherein the separation region includes conductive solid-state electrolyte;
a pressure chamber; and
a plate between one of the anode or cathode regions and the pressure chamber.

19. The system of claim 18, wherein:
the plate is to provide equalized pressure to a housing containing the anode, cathode, and separation regions.
the pressure chamber includes one of: pressured gas, elastic material, elastic foam, spring plate, pressured liquid, deformed metal, expandable material, or mechanical spring;
the pressure chamber includes valve for gas injection;
the conductive solid-state electrolyte comprises Li-ion;
the cathode region includes one of Li, Co, Ni, Mn, Fe, Al, P or O; and
the anode region includes one of Li-metal and Si.

20. The system of claim 19, wherein the battery comprises:
metal end attached to the pressure chamber; and
metal skin to encase portions of the anode, cathode, and separation regions, wherein the metal skin is coupled to the plate.
